(19) United States
(12) Patent Application Publication
(10) Pub. No.: US 2017/0333862 A1
(43) Pub. Date: Nov. 23, 2017

(54) FIXED BED REACTOR AND METHODS RELATED THERETO

(71) Applicant: SABIC GLOBAL TECHNOLOGIES B.V., Bergen op Zoom (NL)

(72) Inventors: Talal Khaled Al-Shammari, Riyadh (SA); Khalid Karim, Riyadh (SA)

(21) Appl. No.: 15/525,162

(22) PCT Filed: Nov. 12, 2015
(86) PCT No.: PCT/IB2015/058749

§ 371 Date: May 8, 2017

Related U.S. Application Data
(60) Provisional application No. 62/079,647, filed on Nov. 14, 2014.

(51) Int. Cl. B01J 8/06; B01J 19/18; C10G 2/00

(52) U.S. Cl. CPC B01J 8/067; C10G 2/341; B01J 8/065; B01J 19/1856; B01J 2208/065

(57) ABSTRACT

The present disclosures and inventions relate reactor and method useful in Fischer-Tropsch processes, such as a reactor comprising a first one or more catalyst holding zones, wherein each of the first one or more catalyst holding zones have a first inner surface, wherein the first inner surface defines a first interior space, wherein each of the first one or more catalyst holding zones have a first longitudinal axis, wherein each of the first one or more catalyst holding zones have a first end and a second end, wherein the first inner surface is tapered towards the first longitudinal axis from the first end towards the second end, and wherein each of the first one or more catalyst holding zones are configured to perform an exothermic reaction.

### CROSS-REFERENCE TO RELATED APPLICATIONS

This Application claims the benefit of U.S. Application No. 62/079,647, filed Nov. 14, 2014, which is incorporated herein by reference in its entirety.

### BACKGROUND

Syngas (mixtures of hydrogen (H₂)) and carbon monoxide (CO)) can be readily produced from either coal or methane (natural gas) by methods well known in the art and widely commercially practiced around the world. A number of well-known industrial processes use syngas for producing various oxygenated organic chemicals. The Fischer-Tropsch catalytic process for catalytically producing hydrocarbons from syngas was initially discovered and developed in the 1920's, and was used in South Africa for many years to produce gasoline range hydrocarbons as automotive fuels. Reactors and methods that efficiently carry out the Fischer-Tropsch catalytic process are desired.

Accordingly, reactors and methods that efficiently carry out the Fischer-Tropsch catalytic process are disclosed herein.

### SUMMARY OF THE INVENTION

Disclosed herein is a reactor comprising a first one or more catalyst holding zones, wherein each of the first one or more catalyst holding zones have a first inner surface, wherein the first inner surface defines a first interior space, wherein each of the first one or more catalyst holding zones have a first longitudinal axis, wherein each of the first one or more catalyst holding zones have a first end and a second end, wherein the first inner surface is tapered towards the first longitudinal axis from the first end towards the second end, and wherein each of the first one or more catalyst holding zones are configured to perform an exothermic reaction.

Also disclosed herein is a method of for producing hydrocarbons comprising the steps of: a) providing a reactor disclosed herein, wherein the first and/or second interior spaces of the first and/or second one or more catalyst holding zones comprises a catalyst suitable for catalyzing an exothermic reaction; b) contacting syngas with the catalyst suitable for catalyzing an exothermic reaction by flowing syngas from the first end to the second end through the first and/or second interior spaces of the first and/or second one or more catalyst holding zones; and c) collecting a first product at the second end of the first and/or second one or more catalyst holding zones, wherein the first product comprises hydrocarbons.

Additional advantages will be set forth in part in the description which follows, and in part will be obvious from the description, or can be learned by practice of the aspects described below. The advantages described below will be realized and attained by means of the chemical compositions, methods, and combinations thereof particularly pointed out in the appended claims. It is to be understood that both the foregoing general description and the following detailed description are exemplary and explanatory only and are not restrictive.

### DESCRIPTION OF THE FIGURES

The accompanying figures, which are incorporated in and constitute a part of this specification, illustrate several aspects and together with the description serve to explain the principles of the invention.

FIG. 1 shows a non-limiting view of a first catalyst holding zone.

FIG. 2 shows a non-limiting view of a reactor with first catalyst holding zones, second catalyst holding zones, and one cooling section.

FIG. 3 shows a non-limiting view of a reactor with first catalyst holding zones, second catalyst holding zones, and two cooling section.

FIG. 4 shows a non-limiting view of a multi tubular reactor comprising catalyst holding zones.

FIG. 5 shows a modeled temperature profile of the reactor of FIG. 2 compared to a conventional multi tubular fixed bed reactor.

FIG. 6. Shows a modeled temperature profile of the reactor of FIG. 3 compared to the reactor of FIG. 2.

Additional advantages of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DETAILED DESCRIPTION

Disclosed herein are materials, compounds, compositions, and components that can be used for, can be used in conjunction with, can be used in preparation for, or are products of the disclosed method and compositions. It is to be understood that when combinations, subsets, interactions, groups, etc. of these materials are disclosed that while specific reference of each various individual and collective combinations and permutation of these compounds cannot be explicitly disclosed, each is specifically contemplated and described herein. For example, if a catalyst component is disclosed and discussed, and a number of alternative solid state forms of that component are discussed, each and every combination and permutation of the catalyst component and the solid state forms that are possible are specifically contemplated unless specifically indicated to the contrary. This concept applies to all aspects of this disclosure including, but not limited to, steps in methods of making and using the disclosed compositions. Thus, if there are a variety of additional steps that can be performed it is understood that each of these additional steps can be performed with any specific aspect or combination of aspects of the disclosed methods, and that each such combination is specifically contemplated and should be considered disclosed.

### 1. Definitions

In this specification and in the claims which follow, reference will be made to a number of terms which shall be defined to have the following meanings:

It must be noted that, as used in the specification and the appended claims, the singular forms “a,” “an” and “the” include plural referents unless the context clearly dictates otherwise. Thus, for example, reference to “a catalyst” includes mixtures of catalysts.

Ranges can be expressed herein as from “ ” one particular value, and/or to “ ” another particular value. When such a range is expressed, another aspect includes from the one particular value and/or to the other particular value. Similarly, when values are expressed as approximations, by use of the antecedent “,” it will be understood that the particular value forms another aspect. It will be further understood that the endpoints of each of the ranges are significant both in relation to the other endpoint, and independently of the other endpoint.

References in the specification and concluding claims to parts by weight, of a particular element or component in a composition or article, denotes the weight relationship between the element or component and any other elements or components in the composition or article for which a part by weight is expressed. Thus, in a compound containing 2 parts by weight of component X and 5 parts by weight of component Y, X and Y are present at a weight ratio of 2:5, and are present in such a ratio regardless of whether additional components are contained in the compound.

A weight percent of a component, unless specifically stated to the contrary, is based on the total weight of the formulation or composition in which the component is included.

As used herein, the terms space time yield (“STY”) refers to the tons or kg of product that is produced per unit time per volume of catalyst.

### 2. Reactor

Exothermic processes, such as Fischer-Tropsch process, are well-known. A Fischer-Tropsch catalytic process produces liquid hydrocarbons (C2-C10) from syngas. This technology is commonly used to produce waxes, however, current development focuses on the production of more valuable hydrocarbons, such as light hydrocarbos (C2-C5), that can be used in the production of olefins. Minimizing wax formation (or zero wax formation) during the Fischer-Tropsch process is challenging. The formation of waxes during the Fischer-Tropsch process can be a result of re-adsorption of already produced hydrocarbons on to the catalyst. The reactors and methods disclosed herein reduce the probability of re-adsorption already produced hydrocarbons on to the catalyst, thereby minimizing the production of waxes.

The Wight Hourly Space Velocity “WHSV” factor (Equation 1) describes catalytic reactors, and denotes the quotient of the mass flow rate of the reactants divided by the mass of the catalyst in the reactor.

$$WHSV = \frac{Reactanat mass flowrate}{catalyst mass} \qquad Equation 1$$

The WHSV correlates with the reactant conversion, where a higher WHSV gives low conversion for same mass of catalyst, this is because of the decrease in residence time.

In a catalytic reactor, such as a tubular reactor, the amount of reactants (in moles) decreases as reactions progresses through the reactor. Therefore, the WHSV decreases along the catalyst bed if the amount of catalyst stays constant throughout the reactor. Said differently, the reactant flow (in moles) decreases along the catalyst bed and catalyst active sites to reactant moles ratio increases along bed length. This increased ratio increases the probability for hydrocarbon products to re-adsorb on the active sites, thereby producing longer hydrocarbon chains, such as heavy hydrocarbons and waxes. The formation of heavy hydrocarbons can be minimized by the reactors and methods disclosed herein by maintaining the same ratio (catalyst mass: reactant moles) along the catalyst bed, thereby controlling reactant residence time.

Catalyst utilization denotes the quotient of moles of the reactants divided by mass of catalyst, it can be called modified WHSV also as shown in Equation 2.

$$catalyst utilization = \frac{Reactant Moles}{Catalyst Wight} \qquad Equation 2$$

Per Equation 2, to keep the catalyst utilization constant less catalyst weight is needed if less reactant moles are present. Thus, if reactant moles are consumed at the initial stages of the reactor, then less catalyst weight is needed at later stages of the reactor for the catalyst utilization to stay constant.

The reactors disclosed herein provide: 1. robust thermal stability, 2. high olefin selectivity, 3. low wax formation, and 4. optimized catalyst utilization.

Disclosed herein is a reactor comprising a first one or more catalyst holding zones, wherein each of the first one or more catalyst holding zones have a first inner surface, wherein the first inner surface defines a first interior space, wherein each of the first one or more catalyst holding zones have a first longitudinal axis, wherein each of the first one or more catalyst holding zones have a first end and a second end, wherein the first inner surface is tapered towards the first longitudinal axis from the first end towards the second end, and wherein each of the first one or more catalyst holding zones are configured to perform an exothermic reaction. The exothermic reaction can be a Fischer-Tropsch reaction.

In one aspect, the reactor can further comprise a second one or more catalyst holding zones, wherein each of the second one or more catalyst holding zones have a second inner surface, wherein the second inner surface defines a second interior space, wherein each of the second one or more catalyst holding zones have a second longitudinal axis, wherein each of the second one or more catalyst holding zones have a first end and a second end, wherein the second inner surface is tapered away from the first longitudinal axis from the first end towards the second end, and wherein each of the second one or more catalyst holding zones are configured to perform an exothermic reaction. The exothermic reaction can be a Fischer-Tropsch reaction.

Also disclosed herein is a reactor comprising a first one or more catalyst holding zones and a second one or more holding zones, wherein each of the first one or more catalyst holding zones have a first inner surface, wherein the first inner surface defines a first interior space, wherein each of the first one or more catalyst holding zones have a first longitudinal axis, wherein each of the first one or more catalyst holding zones have a first end and a second end, wherein the first inner surface is tapered towards the first longitudinal axis from the first end towards the second end, wherein each of the second one or more catalyst holding zones have a second inner surface, wherein the second inner surface defines a second interior space, wherein each of the second one or more catalyst holding zones have a second longitudinal axis, wherein each of the second one or more catalyst holding zones have a first end and a second end, wherein the second inner surface is tapered away from the first longitudinal axis from the first end towards the second end, and wherein each of the first one or more catalyst holding zones and the second one or more catalyst holding zones are configured to perform an exothermic reaction. The exothermic reaction can be a Fischer-Tropsch reaction.

In one aspect, the first interior space comprises free space. In one aspect, the second interior space comprises free space.

The H₂ and CO are catalytically reacted in a Fischer-Tropsch reaction in the catalyst holding zones disclosed herein. Thus, the catalyst holding zones, such as the first one or more catalyst holding zones and the second one or more catalyst holding zones can comprise one or more Fischer-Tropsch catalysts. For example, the first one or more catalyst holding zones can comprise one or more Fischer-Tropsch catalysts. In another example, the second one or more catalyst holding zones can comprise one or more Fischer-Tropsch catalysts. Fischer-Tropsch catalysts are known in the art and can, for example, be Fe based catalysts and/or Co based catalysts and/or Ru based catalysts. Such catalysts are described in U.S. Pat. No. 4,088,671 and U.S. Pat. No. 4,207,248, which are incorporated herein by their entirety, specifically for their disclosure regarding Fisher-Tropsh catalysts.

The gases that are being mixed in the mixing zones described herein can comprise H₂ and CO. The H₂/CO molar ratio of the feed gas to the first mixing zone can be from 0.5 to 4. For example, the H₂/CO molar ratio can be from 1.0 to 3.0, such as, for example, from 1.5 to 3.0, or in another example, from 1.5 to 2.5. It will be appreciated that the H₂/CO molar ratio can control the selectivity of the hydrocarbons that are being produced.

The reactor disclosed herein can be present in a multi tubular fix bed reactor. In one aspect, the reactor comprises two or more first catalyst holding zones. In one aspect, the reactor comprises two or more second catalyst holding zones. In one aspect, the reactor comprises an equal number of first catalyst holding zones and second catalyst holding zones.

In one aspect, the reactor disclosed herein comprises from 1,000 to 50,000 first catalyst holding zones. For example, the reactors comprise from 10,000 to 30,000 first catalyst holding zones.

In one aspect, the reactor disclosed herein comprises from 2 to 50,000 first catalyst holding zones. For example, the reactor disclosed herein comprises from 2 to 30,000 first catalyst holding zones.

In one aspect, the reactor disclosed herein comprises from 2 to 30,000 first catalyst holding zones and from 2 to 30,000 second catalyst holding zones. For example, the reactor can comprise from 1,000 to 25,000 first catalyst holding zones and from 1,000 to 25,000 second catalyst holding zones.

In one aspect, the reactor is an industrial size reactor. For example, the reactor can have a volume of at least 0.5 liter, 1 liter, 2 liters, 5 liters, 10 liters, 20 liters, 50 liters, 100 liters, 250 liters, 500 liters, 1,000 liters, 10,000 liters or 20,000 liters. For example, the reactor can have a volume from 1 liter to 500 liters, such as, for example, from 1 liter to 20 liters. In another example, the reactor can have a volume from 500 liters to 20,000 liters liter, such as, for example, from 1,000 liters to 10,000 liters.

In one aspect, the catalyst holding zone described herein can be a reactor. For example, the catalyst holding zone can have a volume of at least 1 mL, 5 mL, 25 mL, 100 mL, 500 mL, 1,000 mL, 5 liter, 20 liters, 100 liters, or 1,000 liters. For example, the catalyst holding zone can have a volume from 1 mL to 5 liter, such as, for example, from 25 mL to 1000 mL. In another example, the catalyst holding zone can have a volume from 1 mL to 5 liter, such as, for example, from 5 liters to 1,000 liters.

Fischer-Tropsch reactions are highly exothermic. The temperature profile can be controlled in the reactors disclosed herein by utilizing the second catalyst holding zones disclosed herein. The lesser amount of catalyst present at the first end of the second catalyst holding zone as compared to the first catalyst holding zone can stabilize the thermal profile throughout the reactor, thereby creating a more efficient reactor.

The shape of the first inner surface at the first end and second end can be the same, for example, circular, square, or rectangular. In one aspect, the first inner surface at the first end and at the second end is circular.

The shape of the second inner surface at the first end and second end can be the same, for example, circular, square, or rectangular. In one aspect, the second inner surface at the first end and at the second end is circular.

In one aspect, the first inner surface and the second inner surface are adjacent to each other.

In one aspect, the diameter of the first inner surface at the first end is at least 10% larger than the diameter of the first inner surface at the second end. In another aspect, the diameter of the first inner surface at the first end is at least 15% larger than the diameter of the first inner surface at the second end. In yet another aspect, the diameter of the first inner surface at the first end is at least 20% larger than the diameter of the first inner surface at the second end. In yet another aspect, the diameter of the first inner surface at the first end is at least 30% larger than the diameter of the first inner surface at the second end. In yet another aspect, the diameter of the first inner surface at the first end is at least 50% larger than the diameter of the first inner surface at the second end. In yet another aspect, the diameter of the first inner surface at the first end is at least 100% larger than the diameter of the first inner surface at the second end. In yet another aspect, the diameter of the first inner surface at the first end is from 10% to 100%, such as, for example from 20% to 50%, larger than the diameter of the first inner surface at the second end.

In one aspect, the diameter of the second inner surface at the second end is at least 50% larger than the diameter of the second inner surface at the first end. In another aspect, the diameter of the second inner surface at the second end is at least 75% larger than the diameter of the second inner surface at the first end. In yet another aspect, the diameter of the second inner surface at the second end is at least 100% larger than the diameter of the second inner surface at the first end. In yet another aspect, the diameter of the second inner surface at the second end is at least 150% larger than the diameter of the second inner surface at the first end. In yet another aspect, the diameter of the second inner surface at the second end is at least 200% larger than the diameter of the second inner surface at the first end. In one aspect, the diameter of the second inner surface at the second end is from 50% to 200% larger than the diameter of the second inner surface at the first end.

In one aspect, the distance from the first inner surface to the first longitudinal axis at the first end is at least 10% larger than the distance from the first inner surface to the first longitudinal axis at the second end. In another aspect, the distance from the first inner surface to the first longitudinal axis at the first end is at least 15% larger than the distance from the first inner surface to the first longitudinal axis at the second end. In yet another aspect, the distance from the first inner surface to the first longitudinal axis at the first end is at least 20% larger than the distance from the first inner surface to the first longitudinal axis at the second end. In yet another aspect, the distance from the first inner surface to the first longitudinal axis at the first end is at least 30% larger than the distance from the first inner surface to the first longitudinal axis at the second end. In yet another aspect, the distance from the first inner surface to the first longitudinal axis at the first end is at least 50% larger than the distance from the first inner surface to the first longitudinal axis at the second end. In yet another aspect, the distance from the first inner surface to the first longitudinal axis at the first end is at least 100% larger than the distance from the first inner surface to the first longitudinal axis at the second end. In yet another aspect, the distance from the first inner surface to the first longitudinal axis at the first end is from 10% to 100%, such as, for example, from 20% to 50% larger than the distance from the first inner surface to the first longitudinal axis at the second end.

In one aspect, the distance from the second inner surface to the second longitudinal axis at the second end is at least 50% larger than the distance from the second inner surface to the second longitudinal axis at the first end. In another aspect, the distance from the second inner surface to the second longitudinal axis at the second end is at least 75% larger than the distance from the second inner surface to the second longitudinal axis at the first end. In yet another aspect, the distance from the second inner surface to the second longitudinal axis at the second end is at least 100% larger than the distance from the second inner surface to the second longitudinal axis at the first end. In yet another aspect, the distance from the second inner surface to the second longitudinal axis at the second end is at least 150% larger than the distance from the second inner surface to the second longitudinal axis at the first end. In yet another aspect, the distance from the second inner surface to the second longitudinal axis at the second end is at least 200% larger than the distance from the second inner surface to the second longitudinal axis at the first end. In yet another aspect, the distance from the second inner surface to the second longitudinal axis at the second end is from 50% to 200% larger than the distance from the second inner surface to the second longitudinal axis at the first end.

The tapering from the first end to the second end of the catalyst holding zones determines the amount of the catalyst at a particular point of the catalyst holding zones. The degree of tapering of the catalyst holding zones can be changed depending on the reaction conditions, such as the flow rate of syngas, temperature etc. For example, a higher degree of tapering would be desired when the catalyst concentration is high. In one aspect, the tapering of the first inner surface is constant from the first end to the second end. In one aspect, the tapering of the second inner surface is constant from the first end to the second end.

Furthermore, it is desired to have a stable and constant thermal profile throughout the catalyst holding zones. For Fischer-Tropsch processes targeting olefin production, the catalyst bed is very sensitive to the temperature and it is highly desired to avoid temperature peaks at the first third of reactor length. In one aspect, the reactors comprise cooling sections, such as an intercooler system. Multiple cooling sections can be used to control the thermal profile throughout the catalyst holding zones.

In one aspect, the reactor further comprises a one or more cooling sections.

In one aspect, the reactor further comprises a two or more cooling sections.

The reactor can be configured to perform an exothermic reaction, such as a Fisher-Tropsch reaction from about 220 to 350° C., at a pressure from about 3 to 25 bar, and at a space velocity from about 700 to 6000 ml/g/hr. The reactor or catalyst holding zone can be made of a metal material, such as for example, a carbon-steel material or a stainless-steel material. The length of the catalyst holding zone can be from 3 cm to 12 m. The thickness of the wall material in a catalyst holding zone is typically from 0.5 mm to 5 mm.

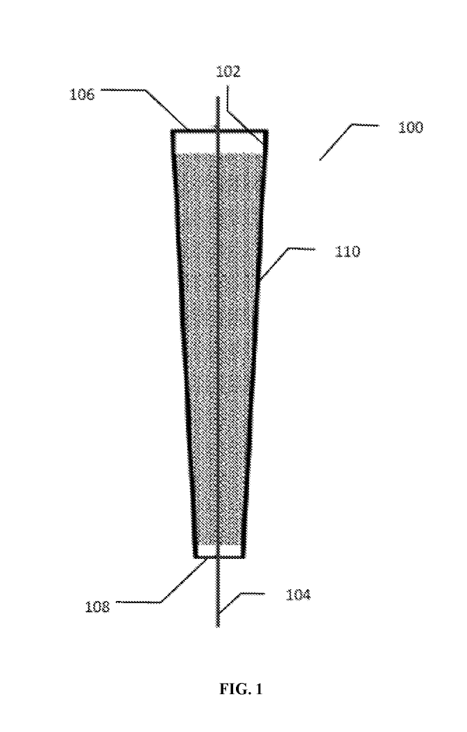

Now referring to FIG. 1, which shows a non-limiting exemplary aspect of the reactors disclosed herein. FIG. 1 shows first catalyst holding zone (100) with a first inner surface (102). The first catalyst holding zone (100) also have a first longitudinal axis (104). The inner surface (102) is tapered toward the first longitudinal axis (104) from the first end (106) to the second end (108). The first catalyst holding zone (100) can also have a first outer surface (110), the first outer surface (110) can be the inner surface of a second catalyst holding zone or a cooling zone. as described herein.

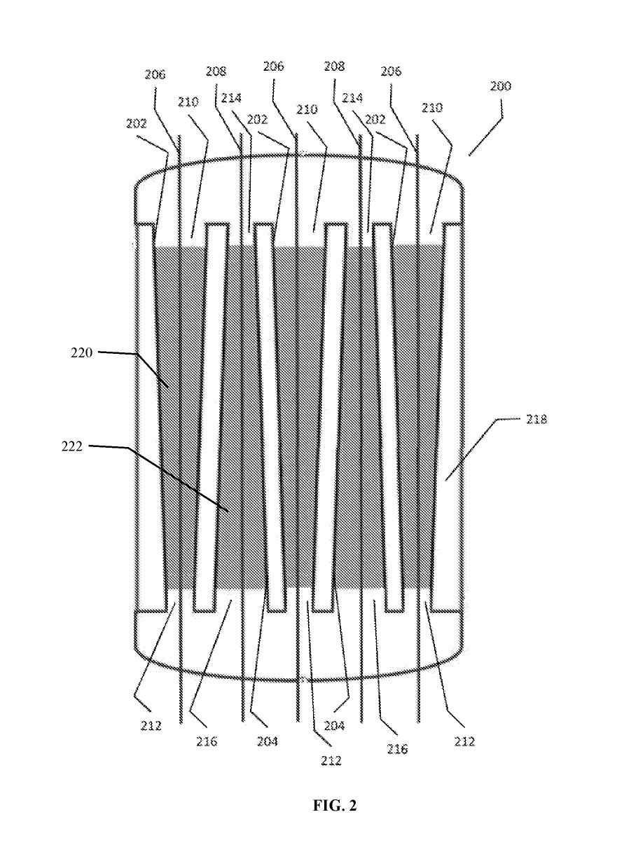

Now referring to FIG. 2, which shows a non-limiting exemplary aspect of the reactors disclosed herein. FIG. 2 shows a reactor (200) with first catalyst holding zones (220) and with second catalyst holding zones (222) as disclosed herein. The first catalyst holding zone of the reactor (200) have a first inner surface (202). The first catalyst holding zone also have a first longitudinal axis (206). The inner surface (202) is tapered toward the first longitudinal axis (206) from the first end (210) to the second end (212). The second catalyst holding zone of the reactor (200) have a second inner surface (204). The second catalyst holding zone have a second longitudinal axis (208). The inner surface (202) is tapered away from the second longitudinal axis (208) from the first end (214) to the second end (216) of the second catalyst holding zone. The reactor (200) can also have a cooling section (218).

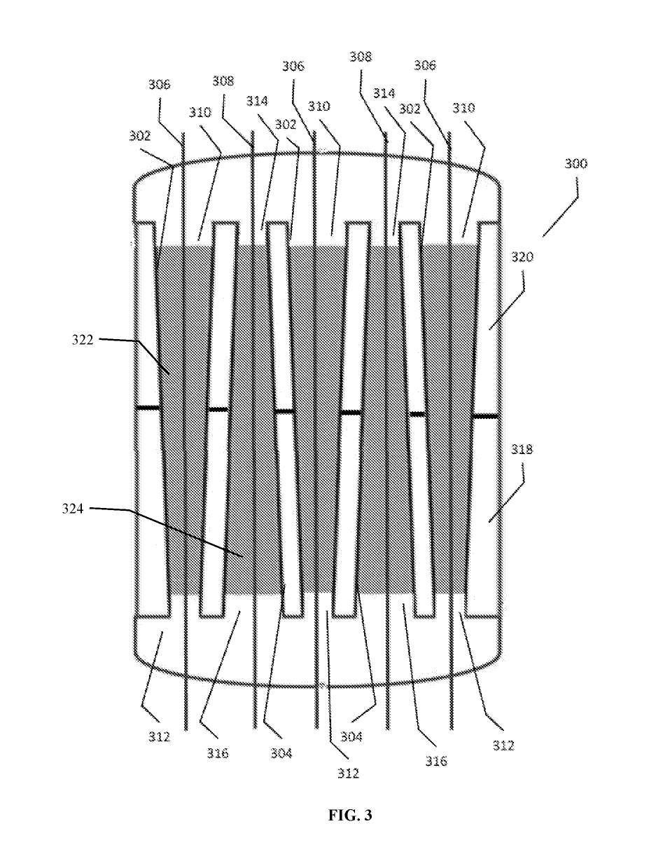

Now referring to FIG. 3, which shows a non-limiting exemplary aspect of the reactors disclosed herein. FIG. 3 shows a reactor (300) with first catalyst holding zones (322) and with second catalyst holding zones (324) as disclosed herein. The first catalyst holding zone of the reactor (300) have a first inner surface (302). The first catalyst holding zone also have a first longitudinal axis (306). The inner surface (302) is tapered toward the first longitudinal axis (306) from the first end (310) to the second end (312). The second catalyst holding zone of the reactor (30) have a second inner surface (304). The second catalyst holding zone have a second longitudinal axis (308). The inner surface (302) is tapered away from the second longitudinal axis (308) from the first end (314) to the second end (316) of the second catalyst holding zone. The reactor (300) can also have two cooling sections (318) and (320).

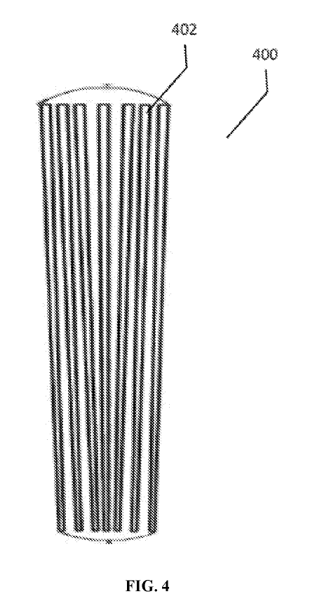

Now referring to FIG. 4, which shows a non-limiting exemplary aspect of the reactors disclosed herein. FIG. 4 shows a reactor (400) with multiple catalyst holding zones (402), such as those described herein, including those shown in FIGS. 1, 2, and 3.

### 3. Methods of Using a Reactor

Also disclosed herein is a method of using the reactors disclosed herein for the production of hydrocarbons.

Also disclosed herein is a method of producing hydrocarbons comprising the steps of: a) providing a reactor disclosed herein, wherein the first and/or second interior spaces of the first and/or second one or more catalyst holding zones comprises a catalyst suitable to catalyze an exothermic reaction, such as a Fisher-Tropsch catalyst; b) contacting a reactant gas, such as syngas, with the catalyst suitable to catalyze an exothermic reaction by flowing syngas from the first end to the second end through the first and/or second interior spaces of the first and/or second one or more catalyst holding zones; and c) collecting a first product at the second end of the first and/or second one or more catalyst holding zones, wherein the first product comprises hydrocarbons.

In one aspect, the hydrocarbons comprise C2-C20+ hydrocarbons. For example, the hydrocarbons comprise C2-C10 hydrocarbons, such as, for example C2-C5 hydrocarbons, such as C2-C3 hydrocarbons.

In one aspect, the catalyst is distributed throughout the first and/or second one or more catalyst holding zones from the first end to the second end.

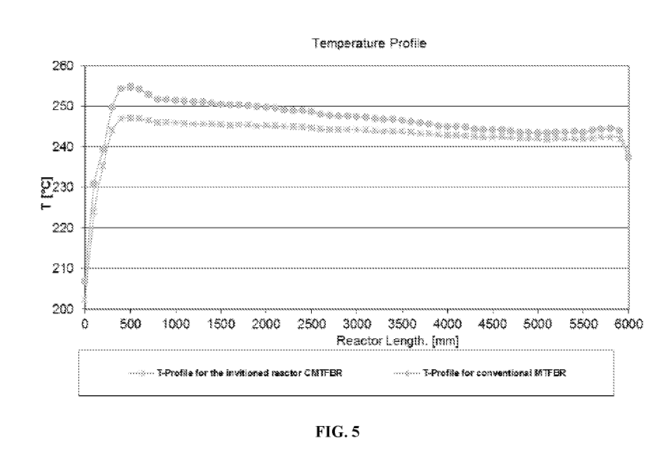

The Fischer-Tropsch reaction is highly exothermic as described herein. It is desired to keep the temperature profile of the reaction constant and without any temperature peaks, which elevates the temperature. Conventional methods, using conventional reaction tubes often comprise a temperature profile with a temperature peak. A temperature peak is a peak in the temperature profile that is at least 5° C. higher than the average reaction temperature through the reactor. For example, FIG. 5 shows that a conventional multi tubular fixed bed reactor has a temperature peak from about 400 mm to about 800 mm of the reactor length. In one aspect, the temperature profile of the methods does not comprise a temperature peak.

In one aspect, a consistent isothermability throughout the reaction process of any exothermic reaction can be achieved by utilizing the reactors and methods disclosed herein.

In one aspect, the syngas is flowed at a pressure ranging from 3 bar to 25 bar. For example, the syngas can be flowed at a pressure ranging from 5 bar to 15 bar.

In one aspect, the first product comprises at least 50% hydrocarbons. In another aspect, the first product comprises at least 75% hydrocarbons. In yet another aspect, the first product comprises from 50% to 75% hydrocarbons. For example, the first product can comprise at least 20% C2-C5 hydrocarbons. In another example, the first product can comprise at least 40% C2-C5 hydrocarbons. In another example, the first product can comprise from 20% to 40% C2-C5 hydrocarbons.

In one aspect, the first product comprises less than 5% wax. For example, the first product can comprise less than 0.1% wax. In another example, the first product can comprise substantially no wax.

In one aspect, at least 30% of the syngas introduced into the reactor is converted into the first product. For example, at least 40% of the syngas introduced into the reactor is converted into the first product. In another example, at least 50% of the syngas introduced into the reactor is converted into the first product. In yet another example, at least 60% of the syngas introduced into the reactor is converted into the first product. In yet another example, at least 70% of the syngas introduced into the reactor is converted into the first product.

### 4. Aspects

In view of the described catalyst and catalyst compositions and methods and variations thereof, herein below are described certain more particularly described aspects of the inventions. These particularly recited aspects should not however be interpreted to have any limiting effect on any different claims containing different or more general teachings described herein, or that the “particular” aspects are somehow limited in some way other than the inherent meanings of the language and formulas literally used therein.

Aspect 1: A reactor comprising a first one or more catalyst holding zones, wherein each of the first one or more catalyst holding zones have a first inner surface, wherein the first inner surface defines a first interior space, wherein each of the first one or more catalyst holding zones have a first longitudinal axis, wherein each of the first one or more catalyst holding zones have a first end and a second end, wherein the first inner surface is tapered towards the first longitudinal axis from the first end towards the second end, and wherein each of the first one or more catalyst holding zones are configured to perform an exothermic reaction.

Aspect 2: The reactor of aspect 1, wherein the reactor further comprises a second one or more catalyst holding zones, wherein each of the second one or more catalyst holding zones have a second inner surface, wherein the second inner surface defines a second interior space, wherein each of the second one or more catalyst holding zones have a second longitudinal axis, wherein each of the second one or more catalyst holding zones have a first end and a second end, wherein the second inner surface is tapered away from the second longitudinal axis from the first end towards the second end, and wherein each of the second one or more catalyst holding zones are configured to perform an exothermic reaction.

Aspect 3: The reactor of aspects 1 or 2, wherein the reactor comprises two or more first catalyst holding zones.

Aspect 4: The reactor of aspects 2 or 3, wherein the reactor comprises two or more second catalyst holding zones.

Aspect 5: The reactor of any one of aspects 11-4, wherein the reactor comprises from 2 to 50,000 first catalyst holding zones.

Aspect 6: The reactor of any one of aspects 11-5, wherein the reactor comprises from 2 to 50,000 second catalyst holding zones.

Aspect 7: The reactor of any one of aspects 1-6, wherein the first inner surface at the first end and at the second end is circular.

Aspect 8: The reactor of any one of aspects 2-7, wherein the second inner surface at the first end and at the second end is circular.

Aspect 9: The reactor of aspects 77 or 88, wherein the diameter of the first inner surface at the first end is at least 10% larger than the diameter of the first inner surface at the second end.

Aspect 10: The reactor of aspects 88 or 9, wherein the diameter of the second inner surface at the second end is at least 10% larger than the diameter of the second inner surface at the first end.

Aspect 11: The reactor of aspects 77 or 88, wherein the area of the space defined by the first inner surface at the first end is at least 10% larger than the diameter of the first inner surface at the second end.

Aspect 12: The reactor of aspects 88 or 9, wherein the area of the space defined by the second inner surface at the second end is at least 10% larger than the diameter of the second inner surface at the first end.

Aspect 13: The reactor of any one of aspects 11-12, wherein the distance from the first inner surface to the first longitudinal axis at the first end is at least 10% larger than the distance from the first inner surface to the first longitudinal axis at the second end.

Aspect 14: The reactor of any one of aspects 22-13, wherein the distance from the second inner surface to the second longitudinal axis at the second end is at least 10% larger than the distance from the second inner surface to the second longitudinal axis at the first end.

Aspect 15: The reactor of any one of aspects 11-14, wherein the tapering of the first inner surface is constant from the first end to the second end.

Aspect 16: The reactor of any one of aspects 22-15, wherein the tapering of the second inner surface is constant from the first end to the second end.

Aspect 17: The reactor of any one of aspects 2-16, wherein the reactor further comprises a one or more coolant sections.

Aspect 18: The reactor of any one of aspects 2-17, wherein the reactor further comprises a two or more coolant sections.

Aspect 19: The reactor of any one of aspects 2-18, wherein the exothermic reaction is a Fischer-Tropsch reaction.

Aspect 20: A method for producing hydrocarbons comprising the steps of: a) providing the reactor of any one of aspects 1-19, wherein the first and/or second interior spaces of the first and/or second one or more catalyst holding zones comprises a catalyst suitable to catalyze an exothermic reaction: b) contacting syngas with the catalyst suitable to catalyze an exothermic reaction catalyst by flowing syngas from the first end to the second end through the first and/or second interior spaces of the first and/or second one or more catalyst holding zones; and c) collecting a first product at the second end of the first and/or second one or more catalyst holding zones, wherein the first product comprises hydrocarbons.

Aspect 21: The method of aspect 2020, wherein the catalyst is distributed throughout the first and/or second one or more catalyst holding zones from the first end to the second end.

Aspect 22: The method of aspects 20 or 2121, wherein the syngas is flowed at a pressure ranging from 3 bar to 25 bar.

Aspect 23: The method of any one of aspects 20-22, wherein the first product comprises at least 50% hydrocarbons.

Aspect 24: The method of any one of aspects 20-23, wherein the first product comprises less than 5% wax.

Aspect 25: The method of any one of aspects 2020-24, wherein at least 30% of the syngas is converted into the first product.

The method of any one of aspects 2020-25, wherein the exothermic reaction is a Fischer-Tropsch reaction.

### EXAMPLES

The following examples are put forth so as to provide those of ordinary skill in the art with a complete disclosure and description of how the compounds, compositions, articles, devices, and/or methods described and claimed herein are made and evaluated, and are intended to be purely exemplary and are not intended to limit the scope of what the inventors regard as their invention. Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. There are numerous variations and combinations of reaction conditions, e.g., component concentrations, desired solvents, solvent mixtures, temperatures, pressures and other reaction ranges and conditions that can be used to optimize the product purity and yield obtained from the described process. Only reasonable and routine experimentation will be required to optimize such process conditions.

### 1. Example 1

This Example describes modeling data for exemplary reactors and methods described herein.

FIG. 2 shows a reactor with first catalyst zones and second catalyst zones and one cooling section. FIG. 5 shows the modeled temperature profile of the reactor shown in FIG. 2. As shown, the temperature profile of a reactor with both first catalyst zones and second catalyst zones does not comprise a temperature peak, while a conventional multi tubular fixed bed reactor does comprise a temperature peak, as modeled.

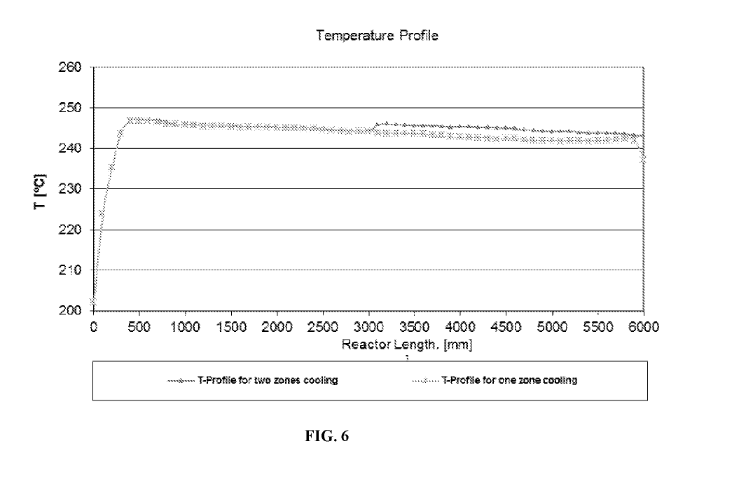

FIG. 3 shows a reactor with first catalyst zones and second catalyst zones and two cooling sections. FIG. 6 shows the modeled temperature profile of the reactor shown in FIG. 3 as compared to the modeled temperature profile of the reactor shown in FIG. 2. As shown, the temperature profile of a reactor with both first catalyst zones and a second catalyst zone and two cooling sections have a more constant modeled temperature as compared to a reactor with both first catalyst zones and second catalyst zones and one cooling section. The benefit of having more than one cooling zone, such as two cooling zones, is to enhance the temperature control at the second half (or last third) of the reactor.

1. A reactor comprising a first one or more catalyst holding zones,
wherein each of the first one or more catalyst holding zones have a first inner surface, wherein the first inner surface defines a first interior space,
wherein each of the first one or more catalyst holding zones have a first longitudinal axis,
wherein each of the first one or more catalyst holding zones have a first end and a second end,
wherein the first inner surface is tapered towards the first longitudinal axis from the first end towards the second end, and
wherein each of the first one or more catalyst holding zones are configured to perform an exothermic reaction.

2. The reactor of claim 1, wherein the reactor further comprises a second one or more catalyst holding zones,
wherein each of the second one or more catalyst holding zones have a second inner surface, wherein the second inner surface defines a second interior space,
wherein each of the second one or more catalyst holding zones have a second longitudinal axis,
wherein each of the second one or more catalyst holding zones have a first end and a second end,
wherein the second inner surface is tapered away from the second longitudinal axis from the first end towards the second end, and
wherein each of the second one or more catalyst holding zones are configured to perform an exothermic reaction.

3. The reactor of claim 1, wherein the reactor comprises two or more first catalyst holding zones.

4. The reactor of claim 2, wherein the reactor comprises two or more second catalyst holding zones.

5. The reactor of claim 1, wherein the reactor comprises from 2 to 50,000 first catalyst holding zones.

6. The reactor of claim 1, wherein the reactor comprises from 2 to 50,000 second catalyst holding zones.

7. The reactor of claim 1, wherein the first inner surface at the first end and at the second end is circular.

8. The reactor of claim 2, wherein the second inner surface at the first end and at the second end is circular.

9. The reactor of claim 8, wherein the diameter of the first inner surface at the first end is at least 10% larger than the diameter of the first inner surface at the second end.

10. The reactor of claim 9, wherein the diameter of the second inner surface at the second end is at least 10% larger than the diameter of the second inner surface at the first end.

11. The reactor of claim 7, wherein the area of the space defined by the first inner surface at the first end is at least 10% larger than the diameter of the first inner surface at the second end.

12. The reactor of claim 8, wherein the area of the space defined by the second inner surface at the second end is at least 10% larger than the diameter of the second inner surface at the first end.

13. The reactor of claim 1, wherein the distance from the first inner surface to the first longitudinal axis at the first end is at least 10% larger than the distance from the first inner surface to the first longitudinal axis at the second end.

14. The reactor of claim 2, wherein the distance from the second inner surface to the second longitudinal axis at the second end is at least 10% larger than the distance from the second inner surface to the second longitudinal axis at the first end.

15. The reactor of claim 1, wherein the tapering of the first inner surface is constant from the first end to the second end.

16. The reactor of claim 2, wherein the tapering of the second inner surface is constant from the first end to the second end.

17. The reactor of claim 2, wherein the reactor further comprises a one or more coolant sections.

18. (canceled)

19. The reactor of claim 2, wherein the exothermic reaction is a Fischer-Tropsch reaction.

20. A method for producing hydrocarbons comprising the steps of:
providing the reactor of claim 1, wherein the first and/or second interior spaces of the first and/or second one or more catalyst holding zones comprises a catalyst suitable to catalyze an exothermic reaction:
contacting syngas with the catalyst suitable to catalyze an exothermic reaction catalyst by flowing syngas from the first end to the second end through the first and/or second interior spaces of the first and/or second one or more catalyst holding zones; and
collecting a first product at the second end of the first and/or second one or more catalyst holding zones, wherein the first product comprises hydrocarbons.

21. The method of claim 20, wherein the catalyst is distributed throughout the first and/or second one or more catalyst holding zones from the first end to the second end.

22.-26. (canceled)
